(19) United States
(12) Patent Application Publication
(10) Pub. No.: US 2015/0300381 A1
(43) Pub. Date: Oct. 22, 2015

(54) VALVE WITH A SPOOL FOR THE CONTROL CIRCUIT OF THE MOTOR OF A VEHICLE

(71) Applicant: PMP PRO-MEC S.P.A., Coseano (UD) (IT)

(72) Inventor: Luigino POZZO, Coseano (UD) (IT)

(73) Assignee: PMP PRO-MEC S.p.A., Coseano (UD) (IT)

(21) Appl. No.: 14/438,826

(22) PCT Filed: Oct. 25, 2013
(86) PCT No.: PCT/EP2013/003214

§ 371 Date: Apr. 27, 2015

(30) Foreign Application Priority Data
Oct. 29, 2012 (IT) UD2012A000182

(51) Int. Cl. F15B 13/06; E02F 9/22

(52) U.S. Cl. CPC F15B 13/06; E02F 9/2278

(57) ABSTRACT

Valve with a spool for the control of the start and of the stop of a hydraulic motor in which an oblong spool is mobile within an oblong seat obtained in a body, the movement of the spool being controllable in two opposite directions of movement by means of control means, the spool being housed within an intermediate portion of the seat in which the intermediate portion has a section size essentially equal to the section size of the spool, the spool being equipped with at least one intermediate portion with respect to a first end and to a second end with a section size smaller than the section size of the intermediate portion of the seat giving rise to the formation of an interstice intended for the reciprocal connection of at least one first duct and a second duct.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a valve with a spool for the hydraulic control circuit of a motor vehicle and/or of a mobile structure or superstructure of a vehicle or working machine according to the characteristics of the pre-characterizing part of claim 1.

The present invention also relates to a control circuit of a motor incorporating the valve in accordance with the present invention according to the characteristics of the pre-characterizing part of claim 12.

The present invention also relates to a vehicle, in particular a working machine, comprising a control circuit of a motor incorporating the valve in accordance with the present invention according to the characteristics of the pre-characterizing part of claim 13.

The present invention also relates to a control method of a hydraulic motor for the movement of a vehicle or working machine and/or for the movement of a structure or superstructure of said vehicle or working machine in which the hydraulic motor is inserted in a control circuit incorporating the valve in accordance with the present invention according to the characteristics of the pre-characterizing part of claim 14.

2. Description of Related Art Including Information Disclosed Under 37 CFR 1.97 and 37 CFR 1.98

In the movement of working machines, either tracked or wheeled, hydraulic motors with an open circuit, with axial pistons and inclined plate or with axial pistons and inclined shaft are widely used. By movement one means both the translation on tracks or wheels of the whole machine, and the rotation of a structure or superstructure of the working machine itself, such as a turret that often also includes the operating cab of the working machine itself and operating means controlled by the operator.

In the field of production of valves, valves with a spool are known in which a mobile element, called spool, is controlled by means of relay control means or by a pressurized fluid introduced into a chamber on which an end of the spool faces or is connected, which is moved thanks to the pressure increase that is created in the chamber and that goes back to the initial position by means of a return spring acting in the opposite direction.

The motors are commonly associated to a multi-stage epicyclic mechanical reduction gear that allows to obtain the rotational speed required for the translation of the working machine or for the rotation of a structure or superstructure present on the working machine itself, generally lower than 50-100 RPM, making the motor run at the optimal rotational speed for the hydraulic motor, generally 1000-4000 RPM, according to the size and type of the motor.

The control of the negative loads of the motor, in particular during braking and motor stop, is commonly entrusted to a counterbalance valve with a single spool. In this specific case of a hydraulic circuit used during the control of the rotation of a structure or superstructure of the working machine itself, commonly the control of the braking of the rotational movement is obtained by means of opposite restrictor valves with progressive setting in which the abrupt movements in case of stop or braking control of the rotation of a structure or superstructure are limited by the progressiveness of the action of the restrictor valves.

In the present state of the art, the counterbalance valve with one single spool controls reactivity both at motor start and at motor stop. Therefore, in the present state of the art in order to make reactivity at start independent of the softness of braking, one resorts to a complex control of the calibrated orifices that adjust in both directions the movement of the balancing spool.

U.S. Pat. No. 6,295,811 describes a valve for a hydraulic motor intended to control a mass having high inertia. The valve includes two main ducts that are respectively intended to be connected to the two main ducts of motor feeding and exhaust. The valve includes a communication duct to put the main ducts in communication when the pressures of the fluid in said ducts are substantially equal and to insulate the main ducts when the pressures of the fluid in said two ducts are different. The device also includes delaying means intended to limit the speed of passage between the situation of communication and the situation of insulation of the ducts.

JP H08 312602 describes a control circuit of a motor that comprises a valve provided with a preload spring in parallel with a flow proportioning valve. The two valves in parallel are placed between a return circuit towards a tank of braking adjustment valves and an input circuit from a tank towards some retaining valves. A spring-loaded valve with a spool is provided, which includes a first closing position, a flow adjusting position, and a second closing position. The valve with a spool is arranged between the delivery lines of the motor with the side of the valve equipped with the spring connected to the tank and the opposite side connected to the circuit of return to the tank with the purpose of improving the volumetric efficiency of the hydraulic motor.

### Problems of the Prior Art

The counterbalance valve for the control of the negative loads of the motor allows to laminate, during stop or the control of negative loads, the pressure that is generated on the side of the rotor connected to the load and due to the inertia of the load itself.

At the release of the lever of the advancing control the open centre spool distributor puts the two main pressure inlets in communication with the low-pressure exhaust tank. In the case of a closed centre distributor of the working machine the depression is induced by the internal recirculation that without a make-up flow prevents the maintenance of a minimum pressure.

In these conditions the motor works as a pump that laminates the pressure produced at the outlet of the counterbalance valve, and there is the suction of the necessary flow of oil from the low-pressure tank. The suction of the necessary flow of oil from a low-pressure tank generally causes a pressure reduction to values dangerous for the wear of the cylinder block and of the interface washers between the rotor and distributor.

In the case in which the counterbalance valve with one single spool is used for the control of the negative loads of the motor, the counterbalance valve with one single spool controls reactivity both in the motor start phase and in the motor stop phase, that is to say, in particular during braking and motor stop. Therefore, in order to make reactivity at start independent of the softness of braking one resorts to a complex control of the calibrated orifices that adjust in both directions the movement of the balancing spool, this solution resulting complex and expensive, as well as more subject to possible obstructions and/or malfunctions.

Furthermore, in the prior art solutions, in the case of open-circuit hydraulic motors for translation controlled by a counterbalance valve, or in the case of hydraulic motors for the control of the rotation of a structure or superstructure of the machine, in the stop phase of the hydraulic motor some oscillations are highlighted due to the inertia of the structure or superstructure and to the consequent pumping effect with the pressure that increases in an intermittent way on the two sides of the rotor.

### BRIEF SUMMARY OF THE INVENTION

The aim of the present invention is to provide a valve for the control of the start and of the stop of a motor of simple realization but that at the same time ensures an effective control of the action of braking and/or of stop of the motor or of the vehicle, preventing the decrease in the pressure of the suction side of the hydraulic motor during the stop of the motor itself.

### Concept of the Invention

The aim is achieved with the characteristics of the main claim. The sub-claims represent advantageous solutions.

### Advantageous Effects of the Invention

The solution according to the present invention, by the considerable creative contribution the effect of which constitutes an immediate and important technical progress, presents various advantages.

The solution according to the present invention advantageously allows to obtain a better control of the actions of braking and/or of stop of the motor without causing pressure reductions to values dangerous for the wear of the cylinder block and of the interface washers between the rotor and distributor; moreover, the present invention prevents the formation of pressure oscillations during the phase of stop of the motor, which normally cause oscillations of the vehicle itself. In a similar way, in the case of a control circuit with a hydraulic motor for the rotation of a structure or superstructure of a working machine, the present invention prevents the formation of pressure oscillations during the stop phase of the rotational movement of the relative structure or superstructure.

Moreover, the solution according to the present invention is simple and economical at the same time allowing for a considerable improvement of the vehicle performances above all regarding the actions of braking and stop of the vehicle.

Advantageously the present invention allows to obtain said benefits both in the case of an open centre circuit with a distributor of the working machine and in the case of a closed centre circuit with a distributor of the working machine.

Advantageously the solution according to the present invention allows, both in the case of a circuit for the movement of a working machine and in the case of a circuit for the rotational control of a structure or superstructure of working machines, a high precision in reaching the rest position of the spool.

### BRIEF DESCRIPTION OF THE DRAWINGS

In the following a solution is described with reference to the enclosed drawings to be considered as a non-exhaustive example of the present invention, in which:

FIG. 1 shows an exploded view of the valve made in accordance with the present invention.

FIG. 2 shows a partially exploded view of the valve of FIG. 1 in which the spool has been inserted into the valve body.

FIG. 3 shows a view of the valve of FIG. 1 in an assembled condition, in a first working condition.

FIG. 4 shows a view illustrating the functional diagram of the valve of FIG. 3.

FIG. 5 shows an illustrative diagram of a first application of the valve according to the present invention in the control diagram of a motor of a vehicle or working machine.

FIG. 6 shows a view of the valve made in accordance with the present invention in the phase of passage from the first working condition to a second working condition.

FIG. 7 shows a view of the valve made in accordance with the present invention in a second working condition.

FIG. 8 shows a view of the valve made in accordance with the present invention in the phase of passage from the second working condition to the first working condition.

FIG. 9 shows a view of the valve made in accordance with the present invention in the phase of passage from the first working condition to a third working condition.

FIG. 10 shows a view of the valve made in accordance with the present invention in a third working condition.

FIG. 11 schematically shows the phases of start and of stop of a motor in accordance with the control method of a motor of a vehicle according to the present invention.

FIG. 12 shows a view of a different embodiment of the valve according to the present invention.

FIG. 13 shows an illustrative diagram of a second application of the valve according to the present invention in the control diagram of a motor that operates a structure or superstructure of a vehicle or working machine.

FIG. 14 shows an enlargement of the portion indicated by “X” in FIG. 12.

### DETAILED DESCRIPTION OF THE INVENTION

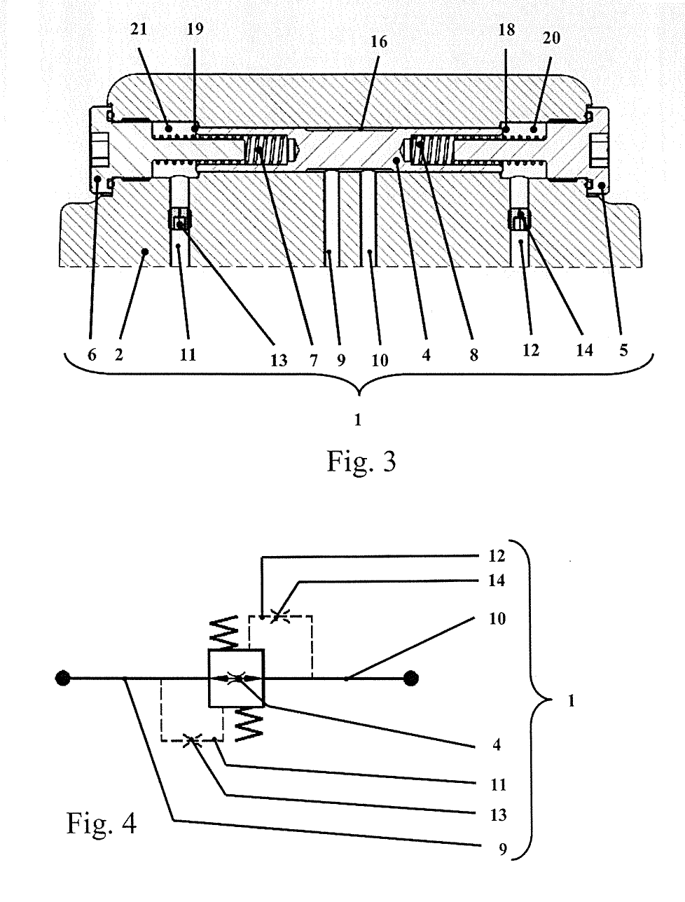

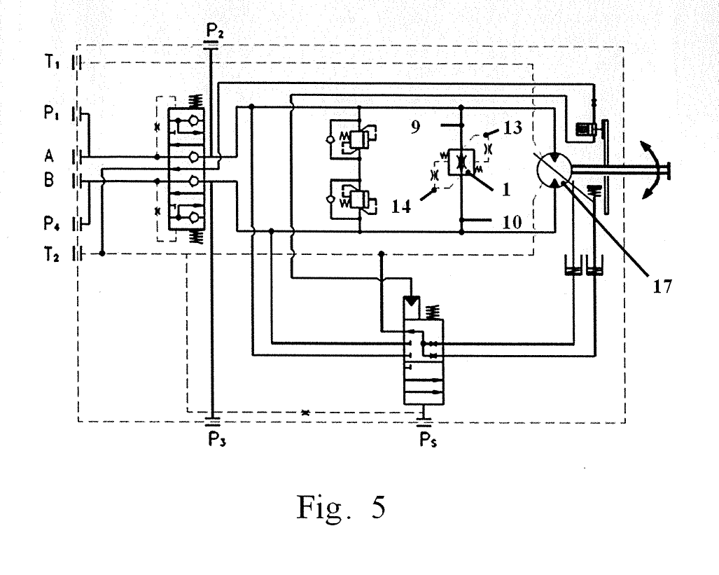

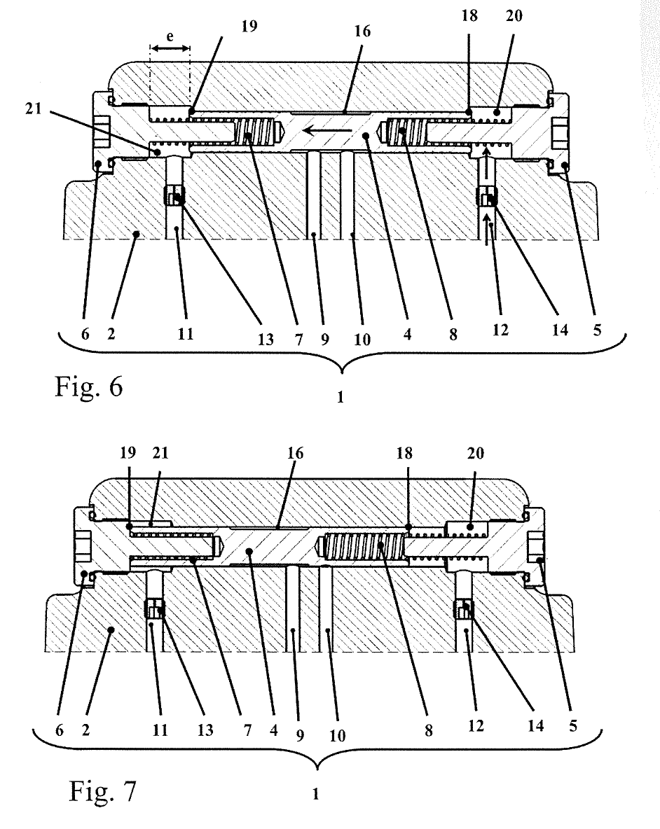

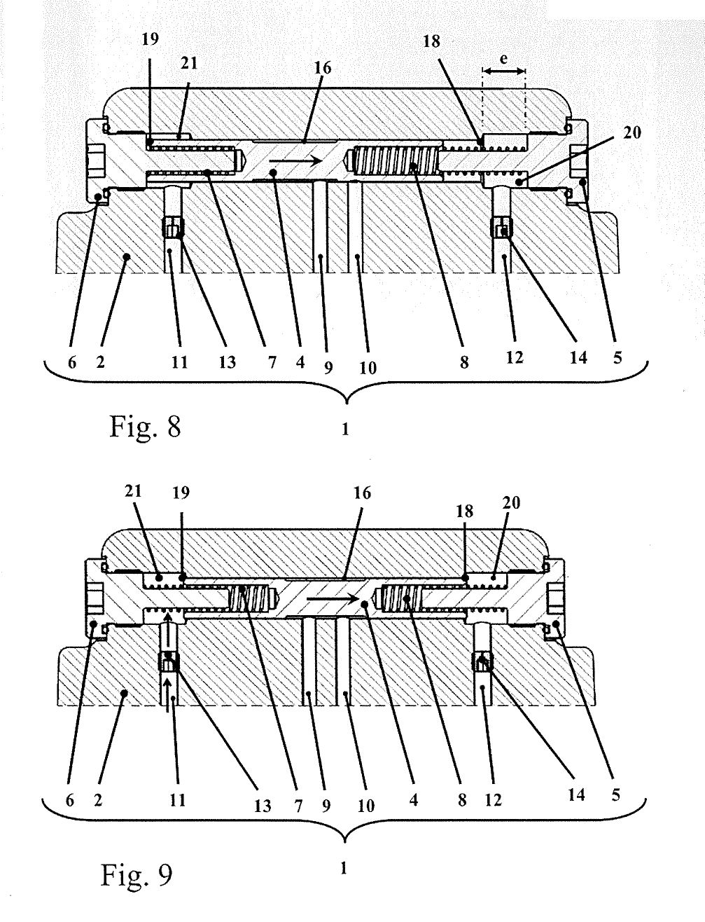

With reference to the figures (FIG. 1, FIG. 3, FIG. 5), the present invention relates to a valve (1) for the control of the start and of the stop of an integrated open-circuit motor (17) for the movement of a working machine.

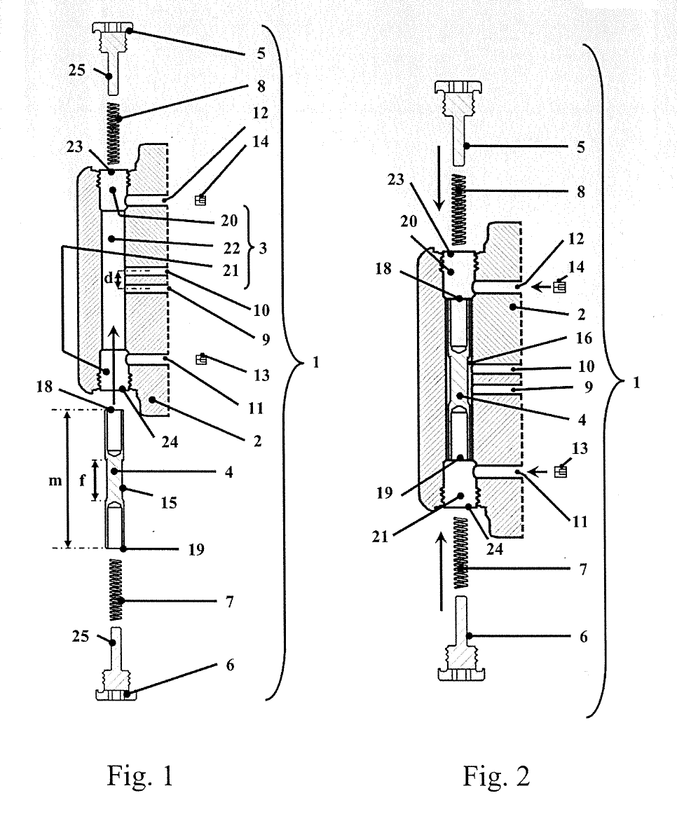

The valve (1) for the control of the start and of the stop of an integrated open-circuit motor (17) for the movement of a working machine according to the present invention is made up of (FIG. 1, FIG. 2) a body (2) within which a seat (3) is obtained into which a spool (4) of oblong shape is inserted bounded by a first end (18) and a second end (19). The spool is a block in one single body with no ducts obtained within the block. The seat (3) has a length greater than the length of the spool and in correspondence of the ends of the seat it has a section size greater than the section size of the spool (4), giving rise to the formation of a first chamber (20) and of a second chamber (21) connected by a third central chamber (22) that has a section size corresponding to the section size of the spool (4). The body (2) is provided with a first control channel (11) for the passage of a fluid between the outside of the valve (1) and the second chamber (21) and with a second control channel (12) for the passage of a fluid between the outside of the valve (1) and the first chamber (20). The body (2) is further provided with a first compensation duct (9) for the passage of a fluid between the outside of the valve (1) and the third chamber (22) and with a second compensation duct (10) for the passage of a fluid between the outside of the valve (1) and the third chamber (22).

The spool (4) is inserted into the seat (3) through a first hole (23) that puts in communication the outside of the body (2) of the valve (1) with the first chamber (20) or, symmetrically, through a second hole (24) that puts in communication the outside of the body (2) of the valve (1) with the second chamber (21). The first hole (23) is closed by a first closing cap (5) that is equipped with a pin (25) which supports a first elastic means (7) exerting a reaction force between the first closing cap (5) fastened to the body (2) and the first end (18) of the spool (4), said reaction force opposing to the displacement movement of the spool (4) that causes the penetration of the spool (4) with the first end (18) into the first chamber (20). The first closing cap (5) advantageously acts also as an abutment element of the spool (4) when the spool (4) moves penetrating the first chamber (20), thus limiting the stresses on the first elastic means (7) which is not excessively compressed extending its duration. Symmetrically the second hole (24) is closed by a second closing cap (6) that is equipped with a pin (25) which supports a second elastic means (8) exerting a reaction force between the second closing cap (6) fastened to the body (2) and the second end (19) of the spool (4), said reaction force opposing to the displacement movement of the spool (4) that causes the penetration of the spool (4) with the second end (19) into the second chamber (21). The second closing cap (6) advantageously acts also as an abutment element of the spool (4) when the spool (4) moves penetrating the second chamber (21), thus limiting the stresses on the second elastic means (8) which is not excessively compressed extending its duration.

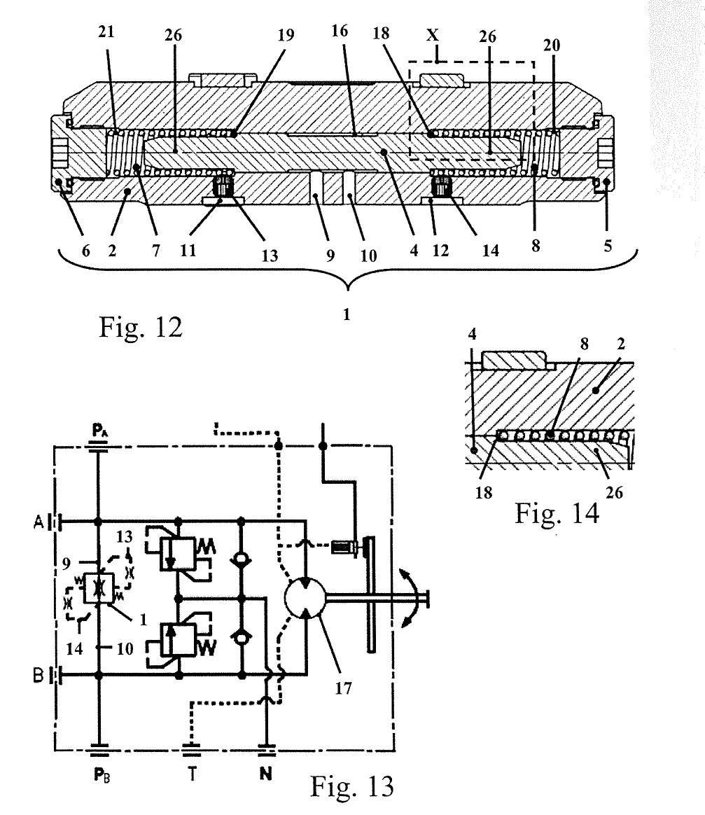

In a different embodiment (FIG. 12) which is particularly useful in the case of a valve with a spool for the application in control circuits of the rotation of a structure or superstructure of a working machine, the first closing cap (5) and the second closing cap (6) have no pin (25). In this case the first elastic means (7) and the second elastic means (8) are kept driven externally by the perimetrically internal walls of the seat (3) while on the spool (4) the function of the pins (25) is performed by corresponding abutment means (26), shaped as pins integral with the spool (4), a first abutment means constituting a protrusion of the spool in correspondence of an end of the spool itself and a second abutment means constituting a protrusion of the spool in correspondence of an opposite end of the spool with respect to the end on which there is the first abutment means. In this case the abutment means (26) replace in practice the pins (25) and the abutment means (26) are joined and integral with the spool (4) also constituting end stop means of the spool (4).

The length (m) of the spool (4) is nearly equal to the length of the third chamber (22). The spool (4) is equipped in correspondence of an approximately central portion with a section narrowing, which, when the spool (4) is in a position inserted in the third chamber (22), gives rise (FIG. 3) to the formation of an interstice (16) having a length (f) of the interstice essentially corresponding but slightly greater with respect to the distance (d) between the first compensation duct (9) and the second compensation duct (10).

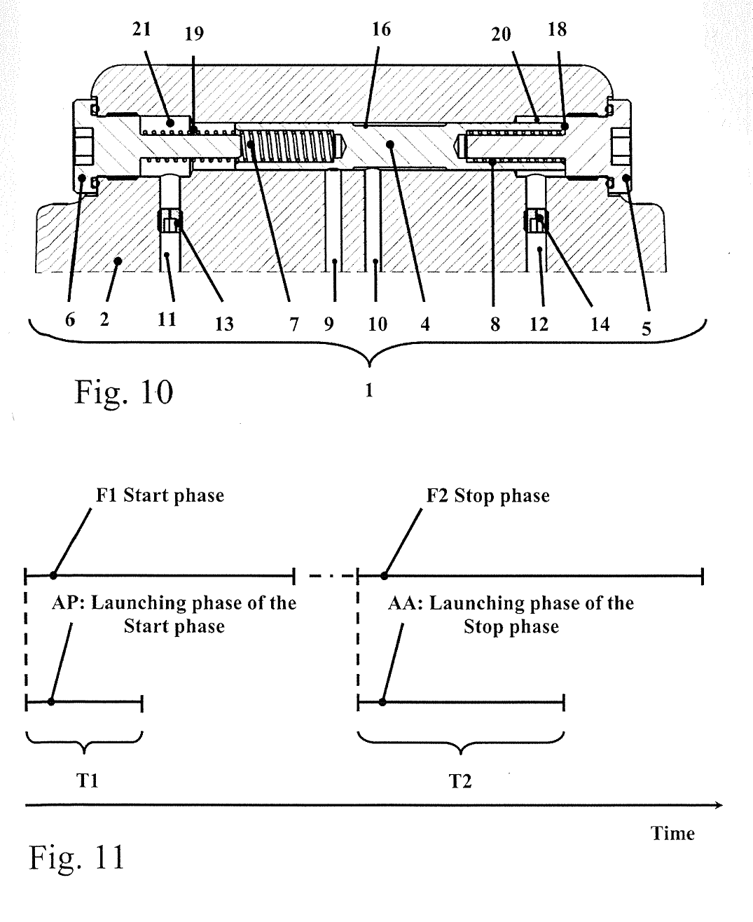

The spool (4) is mobile between at least three positions of which:
a first position (FIG. 10) is a displacement position of the spool (4) which penetrates the first chamber (20) with the first end (18) and in which the interstice (16) is in a condition of non-connection between the first compensation duct (9) and the second compensation duct (10);
a second position (FIG. 7) is a displacement position of the spool (4) which penetrates the second chamber (21) with the second end (19) and in which the interstice (16) is in a condition of non-connection between the first compensation duct (9) and the second compensation duct (10);
a third position (FIG. 3) is an essentially central position of the spool (4) within the third chamber (22) in which the interstice (16) connects the first compensation duct (9) with the second compensation duct (10).

Since the length (f) of the interstice is essentially corresponding but slightly greater with respect to the distance (d) between the first compensation duct (9) and the second compensation duct (10), the connection between the first compensation duct (9) and the second compensation duct (10) occurs only when the spool (4) is in the third position (FIG. 3), that is to say, in the essentially central position of the spool (4) within the third chamber (22). When, on the other hand, the spool (4) has moved with an excursion (e) with respect to the central position within the third chamber (22), that is to say, when the spool (4) is in the first position (FIG. 10) or in the second position (FIG. 7), the interstice (16), which has moved too following the excursion (e), is no longer in a condition of connection between the first compensation duct (9) and the second compensation duct (10), that is to say, the connection between the first compensation duct (9) and the second compensation duct (10) has been interrupted.

The first control channel (11) is equipped with a bottleneck, preferably obtained by means of the insertion into the first control channel (11) of a first restrictor (13). In a similar way the second control channel (12) is equipped with a bottleneck, preferably obtained by means of the insertion into the second control channel (12) of a second restrictor (14). The function of the restrictors (13, 14) will be explained in the following of the present description.

The valve (1) according to the present invention is therefore provided (FIG. 3, FIG. 4) with:
a first compensation duct (9) that, in the application of the valve (1) on a circuit (FIG. 5) for the control of the start and of the stop of a motor (17), is a duct for the compensation flow of the suction vacuum which is in communication with a first side of the rotor of the motor (17);
a second compensation duct (10) that, in the application of the valve (1) on a circuit (FIG. 5) for the control of the start and of the stop of a motor (17), is a duct for the compensation flow of the suction vacuum which is in communication with a second side of the rotor of the motor (17);
a first control channel (11) that constitutes a channel for the control of the movement of the spool, to control the displacement of the spool towards the first position (FIG. 10);
a second control channel (12) that constitutes a channel for the control of the movement of the spool, to control the displacement of the spool towards the second position (FIG. 7).

The first compensation duct (9) and the second compensation duct (10) are (FIG. 3, FIG. 4) independent and separate ducts with respect to the first control channel (11) and second control channel (12).

The solution of the valve (1) according to the present invention will be described as a non-exhaustive example with reference to the illustrative diagram of application for the control of a motor of a vehicle (FIG. 5), being evident to an expert of the field the necessary changes and adaptations in the case of the application of the valve in a control circuit of the rotation of a structure or superstructure of a working machine (FIG. 13). The reference P1 indicates a first pressure tap for a first pressure gauge, the reference P2 indicates a second pressure tap for a second pressure gauge, the reference P3 indicates a third pressure tap for a third pressure gauge, the reference P4 indicates a fourth pressure tap for a fourth pressure gauge for monitoring the pressures of the fluid, preferably oil, that circulates in the circuit. The reference Ps indicates a pressure tap for the control of the capacity change, for example to obtain different rotation speeds. The reference T1 indicates a first drainage connection, while the reference T2 indicates a second drainage connection. In case of the application of the valve in a control circuit of the rotation of a structure or superstructure of a working machine (FIG. 13), the reference N indicates the make-up flow.

During the launching or start of the vehicle and/or during the start of the rotation of a structure or superstructure of the vehicle itself, in particular of a working machine, the operator addresses a flow of oil to one of the two arms of the motor by means of the first inlet (A) or by means of the second inlet (B) according to the rotational direction of the motor (17) that one wishes to obtain. In fact, by addressing a flow of oil by means of the first inlet (A), one addresses the oil to a first arm of the motor (17) making the corresponding rotor turn in a first direction, while by addressing a flow of oil by means of the second inlet (B), one addresses the oil to a second arm of the motor (17) making the corresponding rotor turn in a second direction opposite to the previously defined first direction. The counterbalance valve opens the channels putting the distributor of the vehicle or working machine in communication with the rotary unit of the motor (17).

In case of the application of the valve in a control circuit of the rotation of a structure or superstructure of a working machine (FIG. 12, FIG. 13), the distributor is of the closed centre type and its opening directly opens the passage channels of the flow A and B.

By effect of the system pressure, the valve (1) moves:
from the initial position in which the spool is in the third position (FIG. 3) that is an essentially central position of the spool (4) within the third chamber (22), that is to say, a neutral position,
to the first position (FIG. 10) that is a displacement position of the spool (4) which penetrates the first chamber (20) with the first end (18) and in which the interstice (16) is in a condition of non-connection between the first compensation duct (9) and the second compensation duct (10), or
to the second position (FIG. 7) that is a displacement position of the spool (4) which penetrates the second chamber (21) with the second end (19) and in which the interstice (16) is in a condition of non-connection between the first compensation duct (9) and the second compensation duct (10) according to which of the two inlets (A, B) is used.

Therefore, in these configurations the valve (1) is in a condition in which the interstice (16) is in a condition of non-connection between the first compensation duct (9) and the second compensation duct (10), that is to say, in a condition in which the connecting by-pass consisting of the interstice (16) is in a closed position.

The speed of movement of the spool (4) of the valve (1), that is to say, the time that the spool (4) employs to reach the end-stroke condition corresponding to the abutment condition between the second end (19) of the spool (4) and the second closing cap (6) closing the by-pass, is adjusted by the restrictors (13, 14) that are located within the control channels (11, 12), that is to say, it is adjusted by the first restrictor (13) that is located within the first control channel (11) and by the second restrictor (14) that is located within the second control channel (12). The volume of the flow that with the spool in the third position, that is to say, in the central neutral position, passes through the valve from the pressurized arm to the exhaust arm of the motor (17), is adjusted by the throttling of the by-pass channel obtained by means of the interstice (16). The presence of the interstice (16) allows for a controlled flow between the pressurized arm and the exhaust arm of the motor (17), thus preventing a too fast pressure increase and, therefore, improving comfort at machine start.

Advantageously the solution according to the present invention allows, both in the case of a circuit for the movement of a working machine and in the case of a circuit for the rotational control of a structure or superstructure of operating machines, a high precision in reaching the rest position of the spool, thanks to the compensation for possible differences in the characteristic of the two opposite springs.

In the first embodiment (FIG. 3), differences in the characteristic of the spring are translated into a not perfectly central positioning of the spool, considering that the springs act one against the other and the spool will settle in the position in which the force of the two springs is balanced, this not constituting a particular problem for the operation of the valve itself according to the described methods nor from the point of view of the reaching of the rest position. In particular in the solution described with reference to the embodiment concerning the application of the valve in the case of a circuit for the rotational control of a structure or superstructure of operating machines (FIG. 12, FIG. 14), on the other hand, the springs are pre-loaded against a shoulder of the seat, having an external diameter greater than the spool, and an internal diameter smaller than the spool. Therefore, the certainty of the positioning derives from the position of the worked shoulders, independently of the force—also slightly different because of the normal production tolerances of the springs—which the two springs exert in an opposite direction. Part of this force, in fact, is released on the body, and is transferred entirely to the spool only when the latter leaves the central position. In practice in this configuration the lengthwise extension of the body of the spool (4) excluding the portion corresponding to the supporting means (26) is essentially equal to the lengthwise extension of the intermediate portion (22) of the seat (3). The supporting means (26) have a diameter smaller than the diameter of the spool (4). The intermediate portion (22) has a diameter smaller than the diameter of the remaining portions of the seat (3), that is to say, of the first chamber (20) and second chamber (21). In this way (FIG. 14) the difference of diameter between the supporting means (26) and the spool (4) causes a first step. The difference of diameter between the intermediate portion (22) and the remaining portions of the seat (3) causes a second step. The first step and second step are in a condition of reciprocal alignment when the spool (4) is in the third position that is an essentially central position of the spool (4) within the intermediate portion (22) of the seat (3). The ensemble of the first step and second step with the spool (4) in the third position thus constitutes an abutment and pre-loading shoulder of the first elastic means (7) and second elastic means (8), in such a way that the springs are pre-loaded against said shoulder being certain of the central positioning of the spool thanks to the position of the steps on which part of the force exerted by the elastic means is released.

Afterwards, the spool (4) remains in the abutment position, corresponding to the first position or to the second position, as long as the addressing of the flow of oil by means of the same inlet, first inlet (A) or second inlet (B), used in the phase of launching or start of the vehicle or working machine, continues. For example in a phase of controlled advancement the valve (1) does not intervene, with the spool (4) that remaining at the end of the stroke in the first position or in the second position, according to which side of the motor is pressurized, ensures the overlapping necessary to avoid infiltrations between the arms A and B of the motor and thus ensuring good volumetric efficiency. The restrictors (13, 14) that are located within the control channels (11, 12), that is to say, the first restrictor (13) that is located within the first control channel (11) and the second restrictor (14) that is located within the second control channel (12), do not allow the normal pressure oscillations to move the spool (4), thus ensuring a uniform advancement and without losses in volumetric efficiency.

When afterwards the operator wishes to stop the motor (17), for example to stop the vehicle or working machine or to reverse the travel direction (FIG. 5), or (FIG. 13) to interrupt the rotation of the structure or superstructure in the case of a motor for the rotation of a structure or superstructure of the working machine, such as a turret, the operator acts on the distributor bringing it back to the central position, that is to say, a position in which the addressing of the flow of oil to one of the two arms of the motor by means of the first inlet (A) or by means of the second inlet (B) is interrupted. The corresponding channels connected to the first inlet (A) and to the second inlet (B) are both put in an exhaust condition. The balance valve in this phase goes back to the centre, allowing the motor to work as a pump, driven by the inertia of the vehicle or working machine. The kinetic energy of the machine is lost laminating the flow in the closing balance valve. The reversal of the pressures between the sides A and B of the rotor of the motor causes the movement of the spool (4) of the valve (1) from the end-stroke position in which it is located to the opposite end-stroke position. For example if the spool (4) was located in the first position (FIG. 10) the displacement, that is to say with the spool (4) that is penetrated with the first end (18) within the first chamber (20) and with the closed by-pass channel, then the spool (4), crossing the third position (FIG. 3) that is an essentially central position of the spool (4) within the third chamber (22), will move to the second displacement position (FIG. 7), that is to say, with the spool (4) that is penetrated with the second end (19) within the second chamber (21) and with the closed by-pass channel. In the intermediate phase of this movement of the spool in which the spool is temporarily in the third position (FIG. 3) that is an essentially central position of the spool (4) within the third chamber (22) with the by-pass channel open by means of the interstice (16) between the first compensation duct (9) and the second compensation duct (10), lamination is allowed within the interstice (16) of a part of the flow within the valve (1) instead of the passage through the counterbalance valve. In this way braking is softened. The time in which the by-pass is maintained open in this phase, in which there is the need to soften braking, is twice the time of opening of the by-pass at start, since in this case the spool (4) runs along the whole stroke and makes an excursion equal to twice the excursion (e) relative to the start phase. In fact the spool (4) starts from an end-stroke position to reach the opposite end-stroke position. For example the spool (4) moves from the first position (FIG. 10) to the second position (FIG. 7) or vice versa from the second position (FIG. 7) to the first position (FIG. 10) according to which side of the motor is pressurized. During the start phase, on the other hand, the spool (4) makes only an excursion (e) as it starts from a neutral position, obtained by means of the force exerted by part of two opposite elastic means (7, 8), that is to say, the first elastic means (7) exerting a reaction force between the first closing cap (5) fastened to the body (2) and the first end (18) of the spool (4), and the second elastic means (8) exerting a reaction force between the second closing cap (6) fastened to the body (2) and the second end (19) of the spool (4).

In the control circuit (FIG. 5) of a motor incorporating the valve in accordance with the present invention, the valve (1) is integrated according to a configuration in parallel with at least one counterbalance valve and the valve (1) advantageously prevents the pressure drop of the suction side of the hydraulic motor during the stop of the motor. As a consequence in the solution according to the present invention during the phase of reversal of the pressure between the suction arm and the exhaust arm of the motor (17) the spool (4) of the valve (1) puts in communication the two sides of the rotor of the motor (17), giving rise to a flow that from the exhaust arm and pressurized arm during the braking phase compensates for the vacuum on the suction side of the rotor of the motor (17).

In the prior art solutions the counterbalance valve controls reactivity both of start and of stop of the motor. As a consequence, in order to make reactivity at start independent of the softness of braking, one resorts to a complex control of the calibrated orifices that adjust in both directions the balancing movement. In the prior art solutions for the control of the rotation of a structure or superstructure, both the start and the stop are controlled by the relief valves with progressive setting that act at start limiting the torque induced by the inertia of the structure or superstructure to reach the normal rotational speed, and that operate in braking discharging the kinetic energy accumulated by the inertia of the structure or superstructure. By the solution according to the present invention the braking period is controlled independently of the movement of the balance valve, and can therefore be increased, acting on the excursion (e) of the spool (4) or on the restrictors (13, 14) in such a way as to ensure a sufficiently soft braking. The movement of the balance valve, which with the solution of control circuit (FIG. 5) of the motor according to the present invention is independent of the stop time, can therefore be set to advantageously occur in a shorter time in order to ensure the absence of delay in the start of the vehicle or working machine.

The intensity of braking can be controlled independently of the duration of braking itself through the splitting of the channels that connect the two ends of the spool (4) of the valve (1) and of the channels that connect the two sides, exhaust and suction sides respectively, of the rotor of the motor (17).

In the solutions in which the valve is applied (FIG. 12, FIG. 13) in a circuit for the control of the rotation of a structure or superstructure of a working machine, the valves with progressive setting only cause at the end of braking oscillations of the structure or superstructure caused by the fast reversal of the torque on the motor due to the residual inertia of the structure or superstructure.

By the present invention also in case of malfunctions of the mechanical parking brake, the pressure that is generated on one of the sides of the rotor of the motor (17), due to the weight of the vehicle or working machine, is sufficient to move the spool (4) to the end of the stroke and therefore to insulate the two sides of the rotor of the motor (17), however preventing its rotation with the counterbalance valve at the centre, that is to say, with the control lever not in operation. In this way it is possible to apply the present invention also to tracked operating machines that require a residual braking capacity also in the absence of the intervention of the parking brake.

Furthermore in the solutions (FIG. 5) of a control circuit of an open-circuit hydraulic motor for translation in which the control occurs by means of a counterbalance valve, or in the solutions (FIG. 13) of a control circuit of an open-circuit hydraulic motor for the rotation of the structure or superstructure of a vehicle or working machine, there are some oscillations due to the inertia of the vehicle or working machine and to the consequent pumping effect with the pressure that rises in an intermittent way on the two sides of the rotor. By the present invention, on the other hand, the oscillations of the vehicle or working machine after stopping are considerably reduced thanks to the momentary communication between the two sides of the rotor at each reversal of the pressurized side of the latter.

Therefore, with particular reference to the application of the valve (1) in the control circuit (FIG. 5) of a motor (17) for a vehicle or working machine, advantageously and unlike the prior art solutions, the present invention allows to modulate braking in parallel to the action of the counterbalance valve and moreover allows to adjust the intensity and duration of braking acting on the speed of the valve (1) without affecting the reactivity at start of the working machine, that is to say, without having to act on the speed of the counterbalance valve. Furthermore, advantageously one also obtains a reduction in the vacuum of the rotor when, during braking, the motor works as a pump, reducing the stresses on the motor itself. Furthermore, advantageously one also obtains a sharp reduction or annulment of the oscillations at the end of the stop in the rotations of the structure or superstructure, due to the fast reversal of the couple acting on the motor, in its turn due to the residual inertia of the structure or superstructure of a working machine, in the case of the application of the valve according to the present invention in a circuit (FIG. 13) for the control of the rotation of a structure or superstructure of a working machine.

In conclusion the present invention relates to a valve (1) with a spool (4) in which an oblong spool (4) (FIG. 1, FIG. 2, FIG. 3) is mobile within an oblong seat (3) obtained in a body (2). The movement of the spool (4) is controllable in two opposite directions of movement of the spool (4) by means of control means. The spool (4) is housed (FIG. 3) within an intermediate portion (22) of the seat (3) in which said intermediate portion (22) has a section size essentially equal to the section size of the spool (4). The spool (4) is provided with at least one intermediate portion with respect to a first end (18) and to a second end (19) of the spool (4) in which said at least one intermediate portion has a section size smaller than the section size of the intermediate portion (22) of the seat (3) giving rise to the formation of an interstice (16). The interstice (16) is intended for the reciprocal connection of at least one first duct (9) and second duct (10) for the passage of a fluid between said ducts. The movement of the spool (4) occurs between:
a first position (FIG. 10) that is a displacement position of the spool (4) in a first direction, to this displacement of the spool (4) corresponding a displacement of the interstice (16) that enters a condition of non-connection between the first duct (9) and the second duct (10);
a second position (FIG. 7) that is a displacement position of the spool (4) in a second direction opposite to the first direction, to this displacement of the spool (4) corresponding a displacement of the interstice (16) that enters a condition of non-connection between the first duct (9) and the second duct (10);
a third position (FIG. 3) is an essentially central position of the spool (4) within said intermediate portion (22) of the seat (3) in which the interstice (16) is in a condition of connection between the first duct (9) and the second duct (10).

The interstice (16) has section sizes much smaller than the sizes of the first duct (9) and of the second duct (10), the passage of the fluid between such ducts occurring with the lamination of the flow of the fluid that passes in the interstice.

The passage of the spool (4) from a position selected from:
the first position that is a displacement position of the spool (4) in the first direction;
the second position that is a displacement position of the spool (4) in the second direction opposite to the first direction towards the third position that is an essentially central position of the spool (4) within the intermediate portion (22) of the seat (3) occurs by means of a pair of elastic means (7, 8) consisting of:
   a first elastic means (7) exerting a reaction force opposing to the displacement movement of the spool (4) in the first displacement direction;
   a second elastic means (8) exerting a reaction force opposing to the displacement movement of the spool (4) in the second displacement direction.

The first elastic means (7) and/or the second elastic means (8) are preferably springs, even more preferably helical springs. The first elastic means (7) is supported by a pin (25) integral with a first closing cap (5) of a corresponding hole obtained on the body (2), said first elastic means (7) exerting a reaction force between the first closing cap (5) fastened to the body (2) and a first end (18) of the oblong shape of the spool (4). The second elastic means (8) is supported by a pin (25) integral with a second closing cap (6) of a corresponding hole obtained on the body (2), said second elastic means (8) exerting a reaction force between the second closing cap (6) fastened to the body (2) and a second end (19) of the oblong shape of the spool (4) which is the opposite end of the spool (4) with respect to the first end (18). The first elastic means (7) and the second elastic means (8) exert on the spool (4) forces with an equal modulus and according to reciprocally opposite directions. The first closing cap (5) constitutes an abutment element of the spool (4) in the displacement condition of the spool (4) in the first direction. The second closing cap (6) constitutes an abutment element of the spool (4) in the displacement condition of the spool (4) in the second direction.

In a different embodiment (FIG. 12) the first elastic means (7) and the second elastic means (8) are supported and kept in a driven position by means of a supporting condition operated by the perimetrically internal walls of the seat (3), the spool (4) being provided with supporting means (26) including a first supporting means and a second supporting means, the first supporting means being sliding in an integral way with the spool (4) inside the first elastic means (7) and constituting a protrusion of the body of the spool (4) in correspondence of an end of the spool and the second supporting means constituting a protrusion of the body of the spool (4) in correspondence of an opposite end of the spool (4) with respect to the end on which there is the first supporting means, the supporting means (26) being joined and integral with the body of the spool (4).

One and/or both of the first control channel (11) and the second control channel (12) are provided with a bottleneck, this bottleneck involving an action of adjustment of the time of movement of the spool (4) between the first position, second position, third position, that is to say, involving an action of adjustment of the speed of movement of the spool (4). The bottleneck of the first control channel (11) and/or of the second control channel (12) is obtained by inserting restrictors (13, 14) into the ducts, that is to say, by inserting a first restrictor (13) into the first control channel (11) and/or by inserting a second restrictor (14) into the second control channel (12). The first restrictor (13) and/or the second restrictor (14) are replaceable for the adjustment of the time of movement of the spool (4) between the first position, second position, third position, for example according to the size of the motor (17), to the pressures that are expected in the circuit and to the needs of adjustment of the times of the respective phases that will be described in the following of the present description.

The control means of the movement of the spool (4) are a pair of control channels (11, 12) consisting of a first control channel (11) and a second control channel (12) that flow respectively into a first chamber (20) and in a second chamber (21) obtained within the body (2) in correspondence of opposite sides with respect to a third chamber consisting of the intermediate portion (22) of the seat (3). The first control channel (11) constitutes a channel for the control of the movement of the spool (4) intended to control the displacement of the spool (4) towards the first position (FIG. 10). The second control channel (12) constitutes a channel for the control of the movement of the spool (4) towards the second position (FIG. 7).

Furthermore, the present invention relates to (FIG. 5) a control circuit of a hydraulic motor for the movement of a vehicle or working machine and/or for the movement of a structure or superstructure of the vehicle or working machine, wherein the motor (17) is controllable in a first rotational direction by the introduction of a fluid into a first inlet (A) connected to a first arm of the motor (17) or in a second rotational direction opposite to the first rotational direction by the introduction of fluid into a second inlet (B) connected to a second arm of said motor (17), wherein the control circuit includes a valve (1) with a spool (4) between the first arm and the second arm of said motor (17) and wherein said valve with a spool is shaped and structured as previously described in the present description. In the control circuit the valve (1) is arranged according to a configuration in parallel with a counterbalance valve arranged between the first arm and the second arm of said motor (17).

Furthermore, the present invention relates to a vehicle or working machine comprising the control circuit of a hydraulic motor in which the motor (17) is controllable:
in a first rotational direction by means of the introduction of fluid into the first inlet (A) connected to the first arm of the motor (17), or
in a second rotational direction opposite to the first rotational direction by means of the introduction of fluid into the second inlet (B) connected to the second arm of the motor (17),
wherein the vehicle includes in correspondence of the control circuit of the motor (17) a valve (1) with a spool (4) between the first arm and the second arm of the motor (17) and wherein said valve with a spool is shaped and structured as previously described in this description. In the control circuit the valve (1) is arranged according to a configuration in parallel with a counterbalance valve arranged between the first arm and the second arm of said motor (17).

Furthermore, the present invention relates to (FIG. 11) a control method of a hydraulic motor for the movement of a vehicle or working machine and/or for the movement of a structure or superstructure of the vehicle or working machine in which said method includes:
at least one phase F1 of start of the rotation of the rotor of the motor (17) in a first rotational direction by means of the introduction of fluid into an arm of the motor selected from a first arm connected to a first inlet (A) of the control circuit of the motor and a second arm connected to a second inlet (B) of the control circuit of the motor (17), the introduction of fluid involving a pressure increase in the corresponding arm into which said fluid is introduced, said arm being pressurized;
at least one phase F2 of stop of the rotation of the rotor of the motor (17) by means of the discharge of the pressure from said pressurized arm;
wherein said method, parallel in time with the initial part of the start phase, includes a launching phase AP with a duration T1 of said start phase. The launching phase AP of the start phase F1 is a transfer phase with a controlled flow of the fluid between the pressurized arm and the other of the arms of the motor (17) intended to limit a too rapid pressure increase in the pressurized arm. The duration T1 of the launching phase AP of the start phase F1 is determined by the excursion time of the spool (4) of said previously described valve (1) between the third position and a position selected from:
   first position that is a displacement position of the spool (4) in the first direction;
   second position that is a displacement position of the spool (4) in the second direction opposite to the first direction.

Furthermore, in the control method of a hydraulic motor of a vehicle or working machine, the method (FIG. 11), parallel in time with respect to the initial part of the stop phase F2, includes a launching phase AA with a duration T2 of the stop phase F2, said launching phase AA of the stop phase F2 being a transfer phase with a controlled flow of the fluid between the pressurized arm and the other of the arms of the motor (17) intended to limit a too rapid pressure drop in the pressurized arm, the duration T2 of said launching phase AA of the stop phase F2 being determined by the excursion time of the spool (4) of the previously described valve (1), between a position selected from:
first position that is a displacement position of the spool (4) in the first direction;
second position that is a displacement position of the spool (4) in the second direction opposite to the first direction;
and the opposite position with respect to the initial position of the spool (4) in correspondence of the launching phase AA with a duration T2 of said stop phase F2.

The duration T2 of said launching phase AA of said stop phase F2 is twice the duration T1 of the launching phase AP of the start phase F1.

The description of the present invention has been made with reference to the enclosed figures in a preferred embodiment, but it is evident that many possible changes, modifications and variations will be immediately clear to those skilled in the art in the light of the previous description. Thus, it must be underlined that the invention is not limited to the previous description, but includes all the changes, modifications and variations in accordance with the appended claims.

### NOMENCLATURE USED

With reference to the identification numbers in the enclosed figures, the following nomenclature has been used:
1. Valve
2. Body
3. Seat
4. Spool
5. First closure or first closing cap
6. Second closure or second closing cap
7. First spring or first elastic means
8. Second spring or second elastic means
9. First compensation duct
10. Second compensation duct
11. First control channel
12. Second control channel
13. First restrictor
14. Second restrictor
15. Narrowing
16. Interstice
17. Motor
18. First end
19. Second end
20. First chamber
21. Second chamber
22. Third chamber or intermediate portion of the seat of the spool
23. First hole
24. Second hole
25. Pin
26. Abutment means
A. First inlet
B. Second inlet
d. Distance between compensation channels
e. Excursion of the spool
f. Length of the interstice
m. Length of the spool
N. Make-up flow
P1. First pressure tap for first pressure gauge
P2. Second pressure tap for second pressure gauge
P3. Third pressure tap for third pressure gauge
P4. Fourth pressure tap for fourth pressure gauge
Ps. Pressure tap for the control of the capacity change
T1. First drainage connection
T2. Second drainage connection

1. Valve with a spool for the control of the start and of the stop of a hydraulic motor in which an oblong spool is mobile within an oblong seat obtained in a body, the movement of said spool being controllable in two opposite directions of movement of said spool by means of control means, said spool being housed within an intermediate portion of said seat in which said intermediate portion has a section size that is essentially equal to the section size of said spool, said control means being a pair of control channels comprising a first control channel and a second control channel that flow respectively into a first chamber and into a second chamber obtained within said body in correspondence of opposite sides with respect to a third chamber comprising said intermediate portion of said seat, said first control channel constituting a channel for the control of the movement of said spool in a first control direction, said second control channel constituting a channel for the control of the movement of said spool in a second control direction, said control means being suitable for the movement of said spool between:
a first position that is a displacement position of said spool in a first direction;
a second position that is a displacement position of said spool in a second direction opposite to said first direction;
a third position that is an essentially central position of said spool within said intermediate portion of said seat;
said spool being provided with at least one intermediate part with respect to a first end and to a second end of said spool in which said at least one intermediate part has a smaller section size than the section size of said intermediate portion of said seat giving rise to the formation of an interstice, characterized in that said interstice reciprocally connects at least one first duct and at least one second duct that are independent and separate ducts with respect to said first control channel and said second control channel, said interstice being intended for the passage of a fluid between said first duct and second duct according to the following conditions:
in said first position that is a displacement position of said spool in said first direction, to said displacement of said spool corresponding a displacement of said interstice that enters a condition of non-connection between said first duct and said second duct,
in said second position that is a displacement position of said spool in said second direction opposite to said first direction, to said displacement of said spool corresponding a displacement of said interstice that enters a condition of non-connection between said first duct and said second duct;
in said third position that is an essentially central position of said spool within said intermediate portion of said seat, said interstice being in a condition of connection between said first duct and said second duct;
said valve (1) being further characterised in that the passage of said spool from a position selected from:
said first position that is a displacement position of said spool in said first direction;
said second position that is a displacement position of said spool in said second direction opposite to said first direction;
towards said third position that is an essentially central position of said spool within said intermediate portion of said seat occurs by means of a pair of elastic means comprising:
a first elastic means exerting a reaction force opposing to the displacement movement of said spool in said first displacement direction;
a second elastic means exerting a reaction force opposing to the displacement movement of said spool (4) in said second displacement direction,
in which said first elastic means and said second elastic means act one against the other, the two elastic means exerting their force on said spool in an opposite direction, said two elastic means and said spool being structured so that part of this force is released on the body and it is transferred entirely to the spool only when said spool leaves said third position that is an essentially central position of said spool, in said central position of said spool said two elastic means acting one against the other so that said spool will settle in the position in which the force of the two elastic means is balanced.

2. Valve with a spool for the control of the start and of the stop of a hydraulic motor according to claim 1, characterised in that
said interstice has much smaller section sizes than the sizes of said first duct and said second duct, the passage of said fluid between said ducts occurring with the lamination of the flow of said fluid.

3. Valve with a spool for the control of the start and of the stop of a hydraulic motor according to claim 2, characterised in that said first elastic means and said second elastic means are springs.

4. Valve with a spool for the control of the start and of the stop of a hydraulic motor according to claim 1, characterised in that said first elastic means is supported by a pin which is integral with a first closing cap of a corresponding hole obtained on said body, said first elastic means exerting a reaction force between said first closing cap fastened to said body and a first end of the oblong shape of said spool, and further characterised in that said second elastic means is supported by a pin which is integral with a second closing cap of a corresponding hole obtained on said body, said second elastic means exerting a reaction force between said second closing cap fastened to said body and a second end of the oblong shape of said spool that is the opposite end of said spool with respect to said first end, said first elastic means and said second elastic means exerting on said spool forces with an equal modulus and according to reciprocally opposite directions.

5. Valve with a spool for the control of the start and of the stop of a hydraulic motor according to claim 1, characterised in that said first elastic means and said second elastic means are supported and maintained in a driven position by means of a supporting condition operated by the perimetrically internal walls of said seat, said spool being provided with supporting means including a first supporting means and a second supporting means, said first supporting means being sliding in an integral way with said spool inside said first elastic means and constituting a protrusion of the body of said spool in correspondence of an end of said spool and said second supporting means being sliding in an integral way with said spool inside said second elastic means and constituting a protrusion of the body of said spool in correspondence of an opposite end of said spool with respect to the end on which said first supporting means is present, said supporting means being joined and integral with respect to the body of said spool.

6. Valve with a spool for the control of the start and of the stop of a hydraulic motor according to claim 5, characterised in that the lengthwise extension of the body of said spool excluding the portion corresponding to said supporting means is essentially equal to the lengthwise extension of said intermediate portion of said seat, said supporting means having a diameter smaller than the diameter of said spool, said intermediate portion having a diameter smaller than the diameter of the remaining portions of said seat, the difference of diameter between said supporting means and said spool originating a first step and the difference of diameter between said intermediate portion and the remaining portions of said seat originating a second step, said first step and second step being in a reciprocal alignment condition when said spool is in said third position that is an essentially central position of said spool within said intermediate portion of said seat, the ensemble of said first step and second step with said spool in said third position constituting an abutment and pre-loading shoulder of said first elastic means and second elastic means.

7. Valve with a spool for the control of the start and of the stop of a hydraulic motor according to claim 4, characterised in that said first closing cap constitutes an abutment element of said spool in the displacement condition of said spool in said first direction and further characterised in that said second closing cap constitutes an abutment element of said spool in the displacement condition of said spool (4) in said second direction.

8. Valve with a spool for the control of the start and of the stop of a hydraulic motor according to claim 1, characterised in that said spool is a block in one single body without ducts obtained within the block itself.

9. Valve with a spool for the control of the start and of the stop of a hydraulic motor according to claim 1, characterised in that one and/or both of said first control channel and said second control channel are provided with a bottleneck, said bottleneck involving an action of adjustment of the movement time of said spool between said first position, second position, third position.

10. Valve with a spool for the control of the start and of the stop of a hydraulic motor according to claim 9, characterised in that said bottleneck of said first control channel and/or of said second control channel is obtained by inserting restrictors into said channels, that is to say, by inserting a first restrictor into said first control channel and/or by inserting a second restrictor into said second control channel.

11. Valve with a spool for the control of the start and of the stop of a hydraulic motor according to claim 10, characterised in that said first restrictor and/or said second restrictor are replaceable for the adjustment of the movement time of said spool between said first position, second position, third position.

12. Control circuit of a hydraulic motor for the movement of a vehicle or working machine and/or for the movement of a structure or superstructure of said vehicle or working machine, wherein said motor is controllable in a first rotational direction by the introduction of fluid into a first inlet connected to a first arm of said motor or in a second rotational direction opposite to said first rotational direction by the introduction of fluid into a second inlet connected to a second arm of said motor, characterised in that
it includes said valve with a spool according to claim 1 arranged between said first arm and said second arm of said motor, said valve being arranged according to a configuration in parallel with at least one counterbalance valve arranged between said first arm and said second arm of said motor or with at least one relief valve with progressive setting arranged between said first arm and said second arm of said motor.

13. Vehicle or working machine comprising a control circuit of a hydraulic motor for the movement of said vehicle or working machine and/or for the movement of a structure or superstructure of said vehicle or working machine, wherein said motor is controllable in a first rotational direction by the introduction of fluid into a first inlet connected to a first arm of said motor or in a second rotational direction opposite to said first rotational direction by the introduction of fluid into a second inlet connected to a second arm of said motor, characterised in that it includes said valve with a spool according to claim 1 arranged between said first arm and said second arm of said motor, said valve being arranged according to a configuration in parallel with at least one counterbalance valve arranged between said first arm and said second arm of said motor or to at least one relief valve with progressive setting arranged between said first arm and said second arm of said motor, said valve being provided with said interstice which constitutes a controlled flow interstice between a pressurized arm and an exhaust arm of the motor.

14. Control method of a hydraulic motor for the movement of a vehicle or working machine and/or for the movement of a structure or superstructure of said vehicle or working machine, wherein said method includes:
at least one start phase F1 of the rotation of the rotor of said motor in a first rotational direction by the introduction of fluid into an arm of said motor selected from a first arm connected to a first inlet of the control circuit of said motor and a second arm connected to a second inlet of the control circuit of said motor, the introduction of fluid involving a pressure increase in the corresponding arm into which said fluid is introduced, said arm being pressurized;
at least one stop phase F2 of the rotation of the rotor of said motor (17) by means of the discharge of the pressure from said pressurized arm;
characterised in that
parallel in time with respect to the initial part of said start phase F1 it includes a launching phase AP with a duration T1 of said start phase F1, said launching phase AP of said start phase F1 being a transfer phase with a controlled flow of said fluid between said pressurized arm and the other of the arms of said motor intended to limit a too rapid pressure increase in said pressurized arm, the duration T1 of said launching phase AP of said start phase F1 being determined by the excursion time of said spool of said valve according to claim 1, between said third position and a position selected from:
said first position that is a displacement position of said spool in said first direction;
said second position that is a displacement position of said spool in a second direction opposite to said first direction;
said method being further characterised in that parallel in time with respect to the initial part of said stop phase F2 it includes a launching phase AA with a duration T2 of said stop phase F2, said launching phase AA of said stop phase F2 being a transfer phase with a controlled flow of said fluid between said pressurized arm and the other of the arms of said motor intended to limit a too rapid pressure drop in said pressurized arm, the duration T2 of said launching phase AA of said stop phase F2 being determined by the excursion time of said spool of said valve according to claim 1, between a position selected from:
said first position that is a displacement position of said spool in said first direction;
said second position that is a displacement position of said spool in a second direction opposite to said first direction;
and the opposite position with respect to the initial position of said spool in correspondence of said launching phase AA with a duration T2 of said stop phase F2, the duration T2 of said launching phase AA of said stop phase F2 being twice the duration T1 of said launching phase AP of said start phase F1, said method comprising an intermediate phase of the movement of the spool in which said spool is temporarily in said third position that is an essentially central position of said spool within said intermediate portion of said seat, said phase in which said spool is said third position being a phase in which the volume of the flow that passes through the valve from the pressurized arm to the exhaust arm of the motor, is adjusted by a throttling of the by-pass channel obtained by means of said interstice, said interstice allowing for a controlled flow between the pressurized arm and the exhaust arm of the motor, said phase in which said spool is said third position being a phase in which lamination occurs within the interstice of a part of the flow within the valve instead of the passage through the counterbalance valve.
